(19) United States
(12) Patent Application Publication
(10) Pub. No.: US 2021/0304585 A1
(43) Pub. Date: Sep. 30, 2021

(54) SYSTEM AND METHOD FOR HANDWASHING PROCEDURE COMPLIANCE

(71) Applicant: John Hawatmeh, Bakersfield, CA (US)

(72) Inventor: John Hawatmeh, Bakersfield, CA (US)

(21) Appl. No.: 16/830,018

(22) Filed: Mar. 25, 2020

(51) Int. Cl. G08B 21/24; G06K 19/077; G06K 7/10

(52) U.S. Cl. CPC G08B 21/245; G06K 7/10405; G06K 7/10415; G06K 19/07762

(57) ABSTRACT

Disclosed is a system and method for ensuring that handwashing procedures are being followed. The system may include a computing device which runs an application and administers various system tasks. The system may further include one or more wristbands worn by bearers, the wristbands including at least a radio frequency identification tag and a visual indicator and being connected to a local area network including the computing device. The system may further include one or more readers also connected to the local area network which detect the proximity of wristbands and send signals enabling the administration of the system.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Field

The present invention relates to a system for tracking handwashing compliance, including providing visual feedback.

### 2. Background

The practice of proper hand hygiene has been recognized as an effective way to reduce pathogen transmission in settings such as the health care and food service industries. Hands are one of the main pathways for germ transmission during health care food preparation activities. Despite this, compliance with hand hygiene practices remains low, and improvement efforts tend to lack sustainability. Measuring adherence to hand hygiene practices is therefore important, both to identify where hand hygiene compliance is low, and to determine how compliance may be improved.

Compliance with policies and procedures is often important to ensure health and safety for personnel as well as those many products and services related to the policies and procedures. For example, a company may have handwashing procedures to be followed when operating in a restaurant environment. Failure to follow the procedure may result in contamination, health risks to the personnel operating the restaurant and people who may come in to eat at the restaurant, and other problematic scenarios.

In a specific example, in food handling processes in commercial kitchens, as well as in the medical industry, there is an inherent risk of spreading illness if employees do not follow proper procedures for hand sanitation, e.g., during food preparation, between patient visits, etc. There are mandatory requirements that should be followed for proper handwashing, often specific to the industry or context. However, to a large extent the state of the art relies solely upon employee training and written policies.

Moreover, much of the focus is often placed purely on post restroom use hygiene and other potential sources of contamination are ignored, such as in the service portion of the restaurant, and exterior areas of the restaurant, for example, when throwing out trash.

State of the art approaches for monitoring include identifying personnel who are assigned to perform a task together with operation of various tools used in the task performance. An employee badge or wristband can be used to determine whether assigned personnel are located in the vicinity of the required tools and serve as an indirect indicator that the assigned personnel used the tools to complete the task such as when a badge or wristband is detected near a handwashing station. However, this simply confirms presence and does not address actual compliance with a handwashing procedure. Furthermore, wearable identification devices such as badges can themselves be sources of contamination or other process compromise.

However, measuring worker adherence to hand hygiene guidelines is not a simple matter. There is no standardized measure for collecting and reporting rates of hand hygiene compliance. Different organizations may require very different hand hygiene practices. For example, both how and when hand hygiene hand should be performed may vary widely depending upon the type of establishment. In addition, even within an organization, hand hygiene requirements may vary depending upon a person's job role and their likelihood of coming into contact with, and/or transmitting, pathogens.

For the foregoing reasons, there is a need for a system and method which can monitor employee compliance in real time as well as provide visual feedback to the employee, management, and customers.

### BRIEF SUMMARY

Herein disclosed is a system for ensuring compliance with handwash procedures. The system may include a router for establishing a local area network (LAN). The system may further include a computing device connected to the LAN. The system may include one or more readers connected to the LAN. The one or more readers may emit radio waves at a predetermined bandwidth for radio frequency identification (RFID). The system may further include one or more wristbands connected to the LAN. The wristbands may include a housing, a RFID tag located in the housing, or a visual indicator located in the housing. The visual indicator may have at least two different modes of display. The housing may further include a transceiver located in the housing, a processer located in the housing, and a memory electrically connected to the processor. The system may operate such that when each of the one or more wristbands is detected in proximity of one of the one or more readers using RFID, the one of the one or more readers sends a signal to the computing device. The computing device may then send a signal to the wrist band. The signal may cause a first change in status to a contaminated status. The contaminated status may be indicated by a first change in mode of display by the visual indicator. The wristband may be detected by a one or more readers positioned at a sink in order to cause a second change in status to a clean status. The clean status may be indicated by a second change in mode of display by the visual indicator. The change may be to a mode of display different than that caused by the first change in mode of display.

Further disclosed is a method for manufacturing a system for ensuring compliance with handwash procedures. The method may include providing a router. The router may establish a connection to a local area network (LAN). The method may further include connecting a computing device to the LAN. The method may further include connecting one or more readers to the LAN. The one or more readers may emit radio waves at a predetermined bandwidth for radio frequency identification (RFID). The method may further include connecting one or more wristbands to the LAN. The wristbands may have a housing, a RFID tag located in the housing, an accelerometer located in the housing, or a visual indicator located in or on the housing. The visual indicator may have at least two different modes of display. There may be a transceiver located in the housing, a processer located in the housing, and a memory electrically connected to the processor and storing instructions regarding the accelerometer in the housing. The method may further include that when each of the one or more wristbands may be detected in proximity of one of the one or more readers using RFID, the one of the one or more readers may send a signal to the computing device. The computing device may then send a signal to the wrist band. The signal may cause a first change in status to a contaminated status. The change in status may be indicated by a first change in mode of display by the visual indicator. The wristband may be detected by one or more readers positioned at a sink, and data may be collected by the accelerometer in order to cause a second change in status to a clean status. The change to a clean status may be indicated by a second change in mode of display by the visual indicator. The change in mode of display to a mode of display may be to a different mode than that caused by the first change in mode of display.

Further disclosed may be a system for ensuring compliance with handwash procedures. The system may include a router which may establish a local area network (LAN). The system may further include a computing device, which may be connected to the LAN. The system may include one or more readers. The one or more readers may be connected to the LAN. The one or more readers may emit radio waves at a predetermined bandwidth for radio frequency identification (RFID). The system may further include one or more wristbands connected to the LAN. The one or more wristbands may have a housing, a processer located in the housing, a memory electrically connected to the processor, a RFID tag located in the housing and electrically connected to the processor, an accelerometer located in the housing and electrically connected to the processor, a gyroscope located in the housing and electrically connected to the processor, a visual indicator located in or on the housing and electrically connected to the processor, the visual indicator having at least two different modes of display, and a transceiver located in the housing and electrically connected to the processor. The system may require that when each of the RFID tags in the one or more wristbands is detected in proximity of one of the one or more readers using RFID, that the one of the one or more readers may send a signal to the computing device. The computing device may send a signal to the wrist band. The signal may cause a first change in status to a contaminated status, which may be indicated by a first change in mode of display by the visual indicator. The wristband may include criteria stored in the memory regarding a predetermined number of accelerations detected by the accelerometer. The wristband may further include a predetermined number of rotations detected by the gyroscope. These criteria may be required to be met in order to cause a second change in status to a clean status indicated by a second change in mode of display by the visual indicator. This second change in mode of display may be to a mode of display different than that caused by the first change in mode of display.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic diagram of an exemplary system.

### DETAILED DESCRIPTION

The detailed description set forth below in connection with the appended drawings is intended as a description of the presently preferred embodiment of a system to monitor employee handwashing and provide visual feedback, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

Disclosed is a system and method to monitor employee handwashing and provide visual feedback. A wristband may include a variety of circuitry to address various aspects of handwashing compliance. For example, the wristband may include radio frequency identification (RFID) for one form of proximity detection. The RFID circuitry may be used in conjunction with a plurality of RFID detectors placed around a facility, for example, a restaurant. The wristband may also include an accelerometer or gyroscope, or both for detecting motion of the wristband itself. Using a combination, the wristband can detect, and, with the included circuitry, measure linear motion and rotational motion. The wristband may also include other forms of proximity sensor beyond RFID. For example, the wristband may include a sensor which emits an electromagnetic field or a beam of electromagnetic radiation (infrared, for instance), and looks for changes in the field or return signal. The wristband may also include a visual indicator, for example, a light. The visual indicator may be a light emitting diode (LED) which may display more than one color. For example, the LED may light up both green and red.

The system may further include a plurality of sensor stations. The sensor stations may be placed in a plurality of locations in a facility. The locations within the facility may be chosen based on the likelihood of contamination. For example, there may be a sensor station placed at the restroom because of the likelihood of contamination of employee's hands in that location. The same may be true for the exterior of the facility, because typically, employees interact with trash or other objects that may be contaminated on the exterior of the facility. Finally, there may be a sensor between the kitchen and front of house. The front of house may have a number of areas where employees may come in to contact with contamination, but these are not as prevalent or severe as the restroom or exterior, and may be handled differently.

The wristband may interact with the RFID sensor stations when the employee passes in proximity to a sensor station. For example, when passing in proximity to the restroom sensor station, the sensor station may interact with the wristband to display a red LED. Contemporaneously, the sensor station may send a message to an application running on a computing device that an event has occurred for that wristband, and specifics of the event, for example, entering a contaminated, or “red” condition. The computing device may be a desktop computer, a laptop computer, or a handheld mobile device, or example, a smart phone or a tablet computer, or any device capable of running the required application. The wristband may be reset to an uncontaminated or “green” condition by washing hands. Various sensors within the wristband detect this motion and the wristband changes its condition to a uncontaminated or “green” condition. Contemporaneously, the wristband may send a message to an application running on the computing device reporting the change in condition. Any of the reports, regardless of their source may include a time stamp that the report was sent. All of the reports sent by the various sensor stations and wristbands may be stored in the system by a predetermined period of time, after which period they may be automatically deleted by the system or uploaded to an archive.

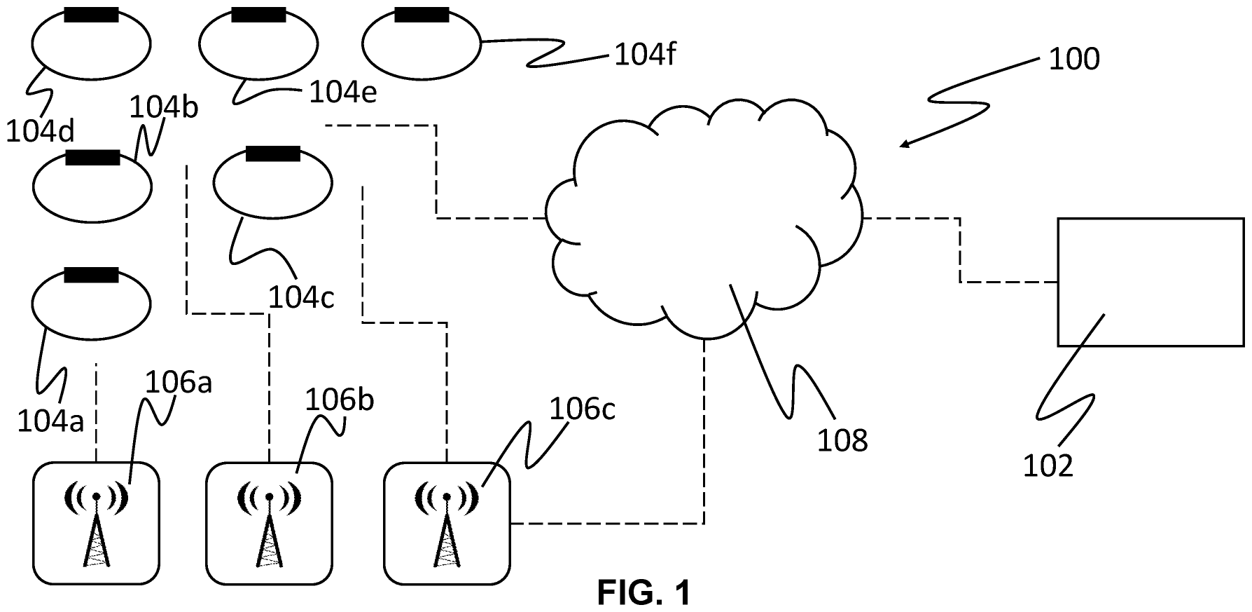

More specifically, with reference to FIG. 1, the system 100 may include a computing device 102 on which the application runs, one or more wristbands 104a-f, and a plurality of sensor stations 106a-c. For example, one exemplary embodiment of the system 100 may include a restroom sensor station 106a adjacent to the entrance to the restroom. In addition, the system may include a sensor station adjacent to the restroom sink. The system may include a sensor station 106b near the exit from the kitchen to the front of house. Similar to the restroom, the kitchen may also have a sensor station located adjacent to the sink. Finally, the system may include a sensor station 106c adjacent to each of the one or more exits from the facility. Each of the sensors 106a-c interacts with the wristbands 104a-f. Some sensors 106a-c may send a signal to turn the visual indicator on the wristband 104a-f red, while others may send a signal to the wristband 104a-f to turn the visual indicator green. Although three sensor stations are shown, it is understood that the system 100 may include fewer than three sensor stations, or more than three sensor stations. Although six wristbands are shown, it is understood that the system 100 may include fewer than six wristbands or more than six wristbands.

The wristbands 104a-f may incorporate either active or passive RFID technology. However, passive RFID technology is preferred, as it is both lower cost, and may prevent false positive proximity detections of wristbands 104a-f at the sensor stations 106a-c. The sensor stations 106a-c, which may also be termed readers, are active. This arrangement is known as an active reader passive tag (ARPT) system. The active reader 106a-c may send radio signals to the passive tag in a wristband 104a-f within proximity. It is the radio signals which power the tag, and cause the tag to send a return signal to the reader 106a-c. The radio signals may be at 13.56 MHz. This frequency is known worldwide as the industrial, scientific, and mechanical (ISM) band, and the band is reserved for such uses.

The wristband 104a-f may further include a transceiver. The transceiver may be adapted to send signals via a wireless protocol, for example the IEEE 802.11 protocol commonly used in WiFi® enabled devices. The transceiver may alternatively use the Bluetooth® protocol or another wireless protocol to communicate with the computing device. To further enable such commination, the wristband 104a-f may also have a memory on which the protocol is stored, and a processor on which to execute the protocol. The memory may be electrically connected to the processor by traces on a circuit board or by other means known in the art. The processor may be connected to the transceiver by traces on a printed circuit board or by other means known in the art. The processor may also be electrically connected to the visual indicator by traces on a circuit board or by other means known in the art. The visual indicator may receive signals from the processor which affect the operation of the visual indicator. For example, the visual indicator may receive signals that cause the visual indicator to turn on or turn off. The visual indicator may further receive signals which cause the visual indicator to remain on, but change colors.

The wristband 104a-f may also send signals to the computing device 102. The wristband 104a-f may send signals regarding status. For example, if the wristband 104a-f moves from a “green” to a “red” status, the wristband 104a-f may send a signal to the computing device 102 each time the signal changes from one status to the other.

Further, the wristband 104a-f may send signals to the readers 106a-c. For example, the reader 106a-c may detect the proximity of the wristband 104a-f, and the reader 106a-c may include a transceiver which is configured to send a signal to the wristband 104a-f in order to change the status of the wristband 104a-f. For example, readers 106a-c at the sinks, both in the restroom and in the kitchen, may send a signal to change the wristband 104a-f status to “green.” The wristband 104a-f, may, in turn, send a signal acknowledgement to the reader 106a-c. Alternatively, the computing device 102 may send the color change signal to the wristband 104a-f based on data from the reader 106a-c, and the wristband 104a-f may send the acknowledgement to the computing device 102. Regardless of which scheme is used, the wristband 104a-f and the reader 106-ac communicate to change the status of the wristband 104a-f and to acknowledge status changes. Readers 106a-c adjacent to the restroom entrance, kitchen exit, and exterior exits may communicate with the wristbands 104a-f to change the wristband 104a-f status to “red.”

In some embodiments, the wristbands 104a-f may include internal motion sensors. For example, the wristbands 104a-f may include an accelerometer, or a gyroscope, or both. The accelerometer may be used in conjunction with the reader at the restroom and kitchen sinks to determine if the wearer of the wristband is complying with handwash procedures in order to change the status and, correspondingly, the visual indicator, to green. The gyroscope may be used in a similar manner. Both the accelerometer and gyroscope may be used in conjunction with the reader at the restroom and kitchen sinks. In some embodiments, there may be no reader at the restroom and kitchen sinks, and the system 100 may rely solely on the accelerometer and gyroscope, in conjunction with parameters stored on the memory of the wristband 104a-f, to determine that handwashing procedures are being followed by wearers of the wristbands 104a-f.

The handwashing procedures may require certain hand motions. The motions may be detectable by the accelerometer and the gyroscope. The reader alone may be able to determine proximity to a sink. Another reader or an alternate form of sensor may be able to determine proximity to a soap dispenser. Both of these are helpful in determining that procedures are being followed, but are less dispositive than if the readers and any reader or sensor associated with the soap dispenser were combined with the accelerometer, gyroscope, or both to present a more complete data picture. Thus, all of these devices or components may be present in the system 100.

All of the components of the wristband 104a-f may be located in a housing. The housing may have a combination of opaque and translucent portions. For example, the housing may include a translucent portion located so that the visual indicator is observable by a viewer in a number of orientations of the wristband 104a-f. The housing by be of a parallelepiped shape or a cylindrical shape with portions of the circumference of the cylinder flattened to provide a better attachment point for band sections. The flattened portions may be centered 180 degrees from one another. The wristband 104a-f may include a band of two sections. A first band section may be attached to, and extend from, one side of a parallelepiped housing, and a second band section may be attached to, and extend from, a second, opposing side of a parallelepiped housing. In embodiments using a generally cylindrical housing, the first band section may be attached to the housing at a first flattened portion of the circumference, and the second band section may be attached to, and extend from, the opposing flattened portion of the circumference. On an opposite end of the band section to their attachment, both the first band section and the second band section may have a clasp portion. The clasp portions may connect to clasp the band sections around a user's wrist.

The computing device 102 stores a record of all status changes. Because a typical restaurant facility has a plurality of staff, the facility will also have a plurality of wristbands 104a-f. Each wristband 104a-f will send a signal, either directly or indirectly, to the computing device 102 each time the status changes. The computing device 102, through an application running on the computing device 102, may store this data for a predetermined period of time. For example, the application on the computing device 102 may have instructions which cause the computing device 102 to store all the data for a week. Alternatively, the computing device 102 may store the data for more than a week or less than a week.

The computing device 102 may connect with a local area network (LAN) 108 to facilitate the sending of signals. The LAN 108 may use the IEEE 802.11 protocol to send and receive messages. Each wristband 104a-f and reader 106a-c may be a separate device on the same LAN 108. Thus, the transceivers in the computing device 102, the wristbands 104a-f, and readers 106a-c may all be peers on the LAN 108.

The readers 106a-c, also called sensor stations, may be located in a plurality of locations in the facility. Each reader may be attached to the facility in one of a plurality of possible ways. Each reader 106a-c may be attached to a wall around a doorway or opening in the facility. Alternatively, each reader 106a-c may be placed in a dedicated cabinet or storage location in the facility. Alternately, each reader 106a-c may be placed in a pre-existing storage area such as a closet. Still further alternatively, the readers 106a-c may be placed in a combination of locations. The placement of the readers 106a-c may take in to consideration the amount of interference any intervening structure may cause with signals passing in between the reader 106a-c and the wristband 104a-f. Also, consideration may be given to any interference intervening structures may cause for signals passing between the reader 106a-c and the computing device 102.

The precise placement may be driven by the accurate detection for the particular purpose. For example, the main consideration for the placement of readers at sink locations may be to determine if a wristband 104a-f is in proximity to the sink where the wristband 104a-f may be placed for handwashing. For readers which detecting wristband 104a-f movement from one part of the facility to another, or from inside the facility to outside the facility, the placement may be to detect all wristbands moving in such a manner, but to avoid false positives. False positives may be when a wristband 104a-f enters the proximity of a reader 106a-c, but the wearer does not actually move between parts of the facility or external to the facility. For example, a wearer in the kitchen may move near the exit to the front of house, but does not exit the kitchen. If the reader 106a-c should report a detection under those circumstances, it would be a false positive because the wearer never left the kitchen.

The readers 106a-c may have some directionality in the transmission of their radio wave signal. The directionality may be used, along with the location of the readers 106a-c to prevent false positive detection of wristbands 104a-f. The directionality may be used to target a location just inside the area which might lead to contamination of the wearer's hands, and not the boundary of the clean and contamination areas generally. In some embodiments, in order to achieve directionality of the readers 106a-c signal, a conductor may be placed on the side of the reader 106a-c were false positives are to be avoided. The conductor will destructively interfere with the signal from the reader 106a-c

In operation, a user may install an application on a computing device 102. The computing device 102 may be a desktop computer. Alternatively, the computing device 102 may be a mobile device, for example a laptop computer, a tablet computer, or a smart device. The computing device 102 may be any device configured to run the application, and including a transceiver configured to make the required communications.

If a LAN 108 does not already exist in the facility, or if the user wishes to create a dedicated LAN 108 for the facility, then a LAN 108 must be set up as is well known in the art. Next, all of the devices may be added to the LAN 108. The readers 106a-c will each be added to the LAN 108, and each of the wristbands 104a-f added to the LAN 108. The application may include a communications check, which will determine that each of the other devices on the system 100 can communicate with the computing device 102 through the LAN 108.

Once communication is established with the readers 106a-c and at least one wristband 104a-f, the system 100 enters an active mode. When a wristband 104a-f is moved from one area of the facility to another, the reader or the computing device 102 may communicate with the wristband 104a-f to change the status of the wristband 104a-f. For example, when the wristband 104a-f is read by a reader moving from a non-contaminated area to the restroom, the reader 106a-c may communicate with the computing device 102 to log the detection. Then, either the reader 106a-c or the computing device 102 may communicate with the wristband 104a-f to change the wristband's 104a-f status in the system 100. This status change may be reflected by the visual indicator. For example, the visual indicator may change from green to red.

The system 100 may change the status of the wristband 104a-f again. Once the same wristband 104a-f completes requirements pre-determined by the system 100 to be indicative of proper handwashing protocol, the reader at the sink or the computing device 102 may change the status of the wristband 104a-f, with the visual indicator of the wristband 104a-f changing from red to green. In some embodiments only a proximity detection by the reader at the sink may be required. In a more complex embodiment, a proximity detection of a reader at the sink and a proximity sensor at a soap dispenser may be required. For example, the soap dispenser may include a light sensor, and only if something moves in the path of transmitted light, and a differing return is detected in addition to a proximity detection by the reader at the sink will the status of a wristband 104a-f be changed.

There may be even more complex requirements for the system 100 to change a wristband 104a-f status, and correspondingly, the visual indicator, from red to green. For example, in addition to any of the requirements above, the system 100 may require that sensors on the wristband 104a-f itself detect certain movements, and report this data to the computing device 102 before the status of the wristband 104a-f is changed. For example, the gyroscope may have to detect certain rotations, and, potentially, a certain number of these rotations, before meeting a requirement stored in instructions on the memory of the wristband 104a-f. Alternatively, or in addition, the accelerometer may have to detect a back and forth movement of the wristband 104a-f, and, potentially, a certain number of back and forth movements of the wristband 104a-f before the criteria stored in instructions stored on the memory of the wristband 104a-f are met. Once all the criteria are met, the wristband 104a-f sends a signal to the computing device 102 with data stating that the criteria are met. The data sent by the wristband 104a-f stating that the criteria have been met may be combined with data from other sources to determine that all handwashing criteria have been met. For example, the data from the wristband 104a-f may be combined with data from the readers 106a-c to determine that all handwashing criteria have been met. The criteria may be a part of the instructions stored in a memory of the computing device 102, and recalled by the application running on the computing device 102. The computing device 102 includes at least one processor to execute these and other instructions that are part of the application. Alternatively, the data from the wristband 104a-f alone may be used to determine that the criteria have been met. When data from the wristband 104a-f alone is used to determine that the criteria have been met, the system 100 may not include readers at the sink.

Readers 106a-c which detect movement of a wristband 104a-f exterior to the building may work a similar way. These readers 106c may have the possible addition of being agnostic regarding direction. That is, a proximity detection will cause a status change of the wristband 104a-f regardless of whether the wristband 104a-f is moving from inside to outside the building or from outside the building to inside the building. This feature accounts for the fact that a bearer may simply be throwing trash out and coming right back in, or may be going home, and, if the bearer keeps the wristband 104a-f as part of the uniform, may turn the wristband 104a-f off, causing it to reset. Thus, the exterior reader 106c will set the wristband 104a-f to contaminated when the bearer enters the facility. Alternatively, the wristband 104a-f may power in contaminated status, and can only have the status changed to clean by being on the same LAN 108 as the computing device 102 and meeting the criteria to send the required data to the computing device 102, causing the computing device 102 to send a change of status signal to the wristband 104a-f.

Some readers 106b may include status changes which are not given effect as soon as the system 100 allows. In some embodiments, the reader 106b which detects movement from the kitchen to the front of house of a wristband 104a-f worn by a bearer will have a delayed status change. For example, once a detection is made by the reader 106b, a signal may be sent to the computing device 102 that the detection was made. At the computing device 102, a timer within the application may be started. The timer may run for a pre-determined amount of time, for example five minutes. After the timer has run the predetermined time, the computing device 102 may send a signal to the wristband 104a-f changing the status of the wristband 104a-f. Correspondingly with the change in status, the visual indicator may change from green to red. Alternatively, the visual indicator may use methods of indication other than color. For example, the visual indicator may show a solid light in a first status, for example, clean, and a flashing light in a second status, contaminated. Once the status has been changed, the bearer of the wristband 104a-f will have to perform the handwashing procedures in order to meet the criteria which causes the system 100 to change the status back to clean, and, correspondingly the visual indicator to green or, as discussed in this paragraph, a solid light.

The above description is given by way of example, and not limitation. Given the above disclosure, one skilled in the art could devise variations that are within the scope and spirit of the invention disclosed herein, including various ways of defining the criteria for changing from a contaminated status to a clean status for a wristband. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system for ensuring compliance with handwash procedures, comprising:
a router for establishing a local area network (LAN);
a computing device connected to the LAN;
one or more readers connected to the LAN, the one or more readers emitting radio waves at a predetermined bandwidth for radio frequency identification (RFID); and
one or more wristbands connected to the LAN, the one or more wristbands having a housing, a RFID tag located in the housing, a visual indicator located in the housing, the visual indicator having at least two different modes of display, a transceiver located in the housing, a processer located in the housing, and a memory electrically connected to the processor;
wherein, when each of the one or more wristbands is detected in proximity of one of the one or more readers using RFID, the one of the one or more readers sends a signal to the computing device, and the computing device sends a signal to the wrist band causing a first change in status to a contaminated status indicated by a first change in mode of display by the visual indicator, and wherein the wristband must be detected by one or more readers positioned at a sink in order to cause a second change in status to a clean status indicated by a second change in mode of display by the visual indicator, to a mode of display different than that caused by the first change in mode of display.

2. The system of claim 1, further comprising an accelerometer located in the housing, instructions stored on the memory requiring that the accelerometer collect data which meet predetermined criteria before the wristband transmits a signal to the computing device with data indicating that handwashing criteria has been met.

3. The system of claim 2, further comprising a gyroscope located in the housing, instructions stored on the memory requiring that the gyroscope collect data which meet predetermined criteria before the wristband transmits a signal to the computing device with data indicating that handwashing criteria has been met.

4. The system of claim 1, wherein the one or more readers includes a reader at every restroom door.

5. The system of claim 1, wherein the one or more readers includes a reader at every restroom door and a reader at every exit door.

6. The system of claim 1, wherein the one or more readers includes a reader at every restroom door, a reader at every exit door, and a reader at every door separating the kitchen from another room.

7. The system of claim 3, wherein the handwashing criteria includes a predetermined number of rotational motions.

8. A method for manufacturing a system for ensuring compliance with handwash procedures, comprising:
providing a router for establishing a local area network (LAN);
connecting a computing device to the LAN;
connecting one or more readers to the LAN, the one or more readers emitting radio waves at a predetermined bandwidth for radio frequency identification (RFID);
connecting one or more wristbands to the LAN, the one or more wristbands having a housing, a RFID tag located in the housing, an accelerometer located in the housing, a visual indicator located in or on the housing, the visual indicator having at least two different modes of display, a transceiver located in the housing, a processer located in the housing, and a memory electrically connected to the processor and storing instructions regarding the accelerometer;
wherein, when each of the one or more wristbands is detected in proximity of one of the one or more readers using RFID, the one of the one or more readers sends a signal to the computing device, and the computing device sends a signal to the wrist band causing a first change in status to a contaminated status indicated by a first change in mode of display by the visual indicator, and wherein the wristband must be detected by one or more readers positioned at a sink, and data collected by the accelerometer in order to cause a second change in status to a clean status indicated by a second change in mode of display by the visual indicator, to a mode of display different than that caused by the first change in mode of display.

9. The method of claim 8, wherein the data collected by the accelerometer includes a predetermined number of accelerations.

10. The method of claim 8, further comprising adding a gyroscope, the gyroscope located in the housing, and instructions stored on the memory requiring that the gyroscope collect data which meet predetermined criteria before the wristband transmits a signal to the computing device with data indicating that handwashing criteria has been met.

11. The method of claim 10, wherein the handwashing criteria includes a predetermined number of rotational movements.

12. The method of claim 8, wherein the one or more readers includes a reader placed at every restroom door, a reader at every exit door, and a reader at every door separating the kitchen from another room.

13. A system for ensuring compliance with handwash procedures, comprising:
a router for establishing a local area network (LAN);
a computing device connected to the LAN;
one or more readers connected to the LAN, the one or more readers emitting radio waves at a predetermined bandwidth for radio frequency identification (RFID); and
one or more wristbands connected to the LAN, the one or more wristbands having a housing, a processer located in the housing, a memory electrically connected to the processor, a RFID tag located in the housing and electrically connected to the processor, an accelerometer located in the housing and electrically connected to the processor, a gyroscope located in the housing and electrically connected to the processor, a visual indicator located in or on the housing and electrically connected to the processor, the visual indicator having at least two different modes of display, and a transceiver located in the housing and electrically connected to the processor;
wherein, when each of the RFID tags in the one or more wristbands is detected in proximity of one of the one or more readers using RFID, the one of the one or more readers sends a signal to the computing device, and the computing device sends a signal to the wrist band causing a first change in status to a contaminated status indicated by a first change in mode of display by the visual indicator, and wherein the wristband includes criteria stored in the memory regarding a predetermined number of accelerations detected by the accelerometer, and includes a predetermined number of rotations detected by the gyroscope in order to cause a second change in status to a clean status indicated by a second change in mode of display by the visual indicator, to a mode of display different than that caused by the first change in mode of display.

14. The system of claim 13, further comprising one or more readers each located adjacent to one or more sinks.

15. The system of claim 14, wherein the one or more readers each located adjacent to the one or more sinks must detect a wristband in order to cause a second change in status to a clean status.

16. The system of claim 13, wherein the one or more readers includes a reader at every restroom door.

17. The system of claim 13, wherein the one or more readers includes a reader at every restroom door and a reader at every exit door.

18. The system of claim 13, wherein the one or more readers includes a reader at every restroom door, a reader at every exit door, and a reader at every door separating the kitchen from another room.

19. The system of claim 13, wherein each of the one or more readers is located above a door.

20. The system of claim 13, wherein each of the one or more readers is located alongside a door.
